(19) United States
(12) Patent Application Publication
(10) Pub. No.: US 2022/0122353 A1
(43) Pub. Date: Apr. 21, 2022

(54) OBJECT RECOGNITION METHOD, APPARATUS, DEVICE AND STORAGE MEDIUM

(71) Applicant: SENSETIME INTERNATIONAL PTE. LTD., Singapore (SG)

(72) Inventors: Wenbin ZHANG, Singapore (SG); Yao ZHANG, Singapore (SG); Shuai ZHANG, Singapore (SG); Shuai YI, Singapore (SG)

(21) Appl. No.: 17/563,782

(22) Filed: Dec. 28, 2021

Related U.S. Application Data
(63) Continuation of application No. PCT/IB2021/062177, filed on Dec. 22, 2021.

(30) Foreign Application Priority Data
Dec. 20, 2021 (SG) 10202114118P

(51) Int. Cl. G06V 10/98; G06V 10/77; G06V 10/88; G06T 7/73; G06V 10/764

(52) U.S. Cl. CPC G06V 10/98; G06V 10/7715; G06V 10/764; G06T 7/73; G06V 10/88

(57) ABSTRACT

An object recognition method includes: at least two consecutive frames of first images each including an image of at least one target object are acquired; a mapping relationship between each of the first images and a preset standard image associated with the target object is determined; object recognition is performed on the target object in each of the first images based on the mapping relationship to obtain a recognition result of the target object in each of the first images; and a target recognition result of the target object is determined based on the recognition results of the target objects in the at least two consecutive frames of first images.

### CROSS-REFERENCE TO RELATED APPLICATIONS

This application is a continuation of International Application No. PCT/IB2021/062177, filed on Dec. 22, 2021, which claims priority to Singaporean Patent Application No. 10202114118P, filed with IPOS on Dec. 20, 2021. The disclosures of International Application No. PCT/IB2021/062177 and Singaporean Patent Application No. 10202114118P are hereby incorporated by reference in their entireties.

### BACKGROUND

In related art, when a conventional recognition algorithm is used to recognize an object in an image, there are usually errors with small probability of occurrence.

### SUMMARY

The embodiments of the present disclosure relate to the field of image processing, and in particular, to an object recognition method, apparatus, device, and storage medium.

The embodiments of the present disclosure provide a technical solution for object recognition.

The technical solution in the embodiments of the present disclosure is implemented as follows:

The embodiments of the present disclosure provide an object recognition method. The method includes the following steps. At least two consecutive frames of first images each including an image of at least one target object are acquired. A mapping relationship between each of the first images and a preset standard image associated with the target object is determined. Object recognition is performed on the target object in each of the first images based on the mapping relationship to obtain a recognition result of the target object in each of the first images. A target recognition result of the target object is determined based on the recognition results of the target objects in the at least two consecutive frames of first images.

The embodiments of the present disclosure provide an object recognition apparatus. The apparatus includes a memory storing processor-executable instructions and a processor. The processor is configured to execute the stored processor-executable instructions to perform operations of: acquiring at least two consecutive frames of first images each comprising an image of at least one target object; determining a mapping relationship between each of the first images and a preset standard image associated with the target object; performing object recognition on the target object in each of the first images based on the mapping relationship to obtain a recognition result of the target object in each of the first images; and determining a target recognition result of the target object based on the recognition results of the target objects in the at least two consecutive frames of first images.

The embodiments of the present disclosure provide a non-transitory computer-readable storage medium having stored thereon instructions that, when executed by a processor, cause the processor to perform operations of: acquiring at least two consecutive frames of first images each comprising an image of at least one target object; determining a mapping relationship between each of the first images and a preset standard image associated with the target object; performing object recognition on the target object in each of the first images based on the mapping relationship to obtain a recognition result of the target object in each of the first images; and determining a target recognition result of the target object based on the recognition results of the target objects in the at least two consecutive frames of first images.

### BRIEF DESCRIPTION OF THE DRAWINGS

In order to more clearly describe the technical solutions in the embodiments of the present disclosure, the following will briefly introduce the drawings needed in the description of the embodiments. It is apparent that the drawings in the following description are only some implementations of the embodiments of the present disclosure. For a person of ordinary skill in the art, other drawings may be obtained according to these drawings without creative effort.

FIG. 1 illustrates a schematic flowchart of an object recognition method according to an embodiment of the present disclosure.

FIG. 2 illustrates a schematic flowchart of a second object recognition method according to an embodiment of the present disclosure.

FIG. 3 illustrates a schematic flowchart of a third object recognition method according to an embodiment of the present disclosure.

FIG. 4 illustrates a schematic composition diagram of an object recognition apparatus according to an embodiment of the present disclosure.

FIG. 5 illustrates a schematic composition diagram of a computer device according to an embodiment of the present disclosure.

### DETAILED DESCRIPTION

In order to make the objectives, technical solutions, and advantages in the embodiments of the present disclosure clearer, the specific technical solutions of the invention will be described in further detail below in combination with the drawings in the embodiments of the present disclosure. The following embodiments are used to illustrate the embodiments of the present disclosure, but are not used to limit the scope of the embodiments of the present disclosure.

In the following description, “some embodiments” are referred to, which describe a subset of all possible embodiments, but it may be understood that “some embodiments” may be the same subset or different subsets of all possible embodiments, and may be combined with each other without conflict.

In the following description, the term “first\second\third” involved only distinguishes similar objects, and does not represent a specific order for the objects. It may be understood that the specific order or sequence of “first \second\third” may be interchanged if permitted, so that the embodiments of the present disclosure described herein may be implemented in a sequence other than those illustrated or described herein.

Unless otherwise defined, all technical and scientific terms used herein have the same meaning as commonly understood by a person skilled in the technical field belonging to the embodiments of the present disclosure. The term used herein is only for the object of describing the embodiments of the present disclosure, and is not intended to limit the embodiments of the present disclosure.

Before describing the embodiments of the present disclosure in further detail, the terms and terms involved in the embodiments of the present disclosure will be described. The terms and terms involved in the embodiments of the present disclosure are applicable to the following explanations.

1) The top view is a view obtained by orthographic projection from above the object.

2) Image binarization is the process of setting the gray value of the pixel points on the image to 0 or 255, that is, the entire image presents an obvious black and white effect.

3) Transformation matrix is a concept in mathematical linear algebra. In linear algebra, linear transformation may be represented by matrices. If T is a linear transformation that maps Rn to Rm, and x is a column vector with n elements, the m×n matrix A is called as the transformation matrix of T.

Exemplary applications of the object recognition device according to the embodiments of the present disclosure will be described in the following. The device according to the embodiments of the present disclosure may be implemented as various types of user terminals, such as a notebook computer, tablet computer, desktop computer, camera, mobile device (for example, personal digital assistant, dedicated messaging device, and portable game device), and may also be implemented as servers. In the following, exemplary applications when the device is implemented as a terminal or a server will be described.

The method may be applied to a computer device, and the functions implemented by the method may be implemented by a processor in the computer device calling program code. Certainly, the program code may be stored in a computer storage medium, and it may be seen that the computer device at least includes a processor and a storage medium.

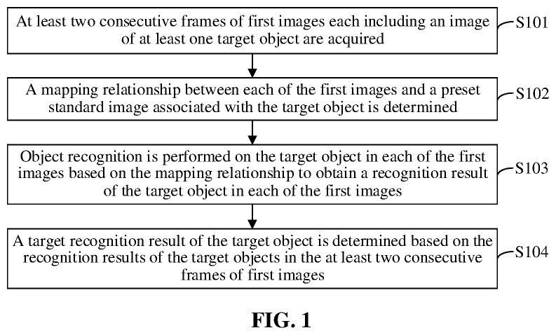

The embodiments of the present disclosure provide an object recognition method. As illustrated in FIG. 1 which illustrates a schematic flowchart of an object recognition method according to an embodiment of the present disclosure; the steps illustrated in FIG. 1 will be described in combination:

In S101, at least two consecutive frames of first images each including an image of at least one target object are acquired.

In some embodiments, at least two consecutive frames of first images may be acquired by the object recognition apparatus through an internal image acquisition module; may also be sent by an apparatus or device capable of information interaction with the object recognition apparatus; may further be acquired by capturing a video by the object recognition apparatus through an internal camera apparatus and splitting the video. In at least two consecutive frames of first images, the image acquisition timings of two adjacent frames of first images are adjacent.

In some embodiments, the first image may be a color image or a grayscale image. The target object may be located in the foreground region, the middle background region, and the background region of the first image.

In some embodiments, the first images may be image data obtained by acquiring images of game props on the game table, such as game tokens or playing cards, and the first images may also be image data obtained by acquiring images of chess pieces on the board. The target object in the first image may be placed in the object placement region; for example, the object placement region is a game desktop, and the target object may be a game prop. For example: stacked game tokens or stacked playing cards; the object placement region is a chess board, and the target object may be chess pieces, such as chess, go, etc. Herein, the area, size, and shape of the object placement region may be determined according to actual needs.

In some embodiments, the number of target objects may be one, two or more; furthermore, when the number of target objects is at least two, the at least two target objects may be objects of the same category or multiple categories. Exemplarily, the target object may be a variety of game tokens of different face values.

In some embodiments, the target object is not occluded in the at least two consecutive frames of first images, and there is no occlusion in the object placement region where the target object is located.

In some embodiments, by acquiring at least two consecutive frames of first images, real-time uninterrupted acquisition of the target object may be achieved, and then the target recognition result of the target object is subsequently determined according to the at least two consecutive frames of first images. Compared with a single image to determine the target recognition result of the target object, the accuracy is higher.

In S102, a mapping relationship between each of the first images and a preset standard image associated with the target object is determined.

In some embodiments, the preset standard image associated with the target object may refer to the top view standard image obtained by acquiring an image of the target object with the image acquisition image set above the center of the object placement region placed with the target object; there is no occlusion of the target object and the object placement region of the target object in the preset standard image.

In some embodiments, the mapping relationship may be represented by a mapping transformation matrix that maps a preset standard image to each of the first images. Exemplarily, the mapping relationship is a transformation matrix that represents the pixel coordinates of at least four actual reference points in the preset standard image and the pixel coordinates of the corresponding reference points in each of the first images.

In some embodiments, the mapping relationship between each of the first images and the preset standard image may be the same or different.

In some embodiments, the preset standard image may be a preset standard image, and the reference image associated with the target object is a standard image for subsequent comparison with the first image. In such a way, by acquiring the top view standard image corresponding to the first image, that is, the preset standard image, the accuracy of subsequent recognition of the target object in the first image may be improved.

In S103, object recognition is performed on the target object in each of the first images based on the mapping relationship to obtain a recognition result of the target object in each of the first images.

In some embodiments, the object recognition apparatus performs object recognition on the target object in each of the first images based on the mapping relationship, and correspondingly obtains the recognition result of the target object in each of the first images. The recognition result of the target object in each of the first images includes, but is not limited to: the category and value of the target object in each of the first images, and the number corresponding to each category and each value.

In some embodiments, based on the mapping relationship, the image reference region corresponding to the object placement region where the target object is placed in the preset standard image may be projected correspondingly to each of the first images, thereby obtaining the to-be-recognized region corresponding to the object placement region where the target object is placed in each of the first image. Then, object recognition is performed on the target object in the to-be-recognized region in each of the first images, and the recognition result of the target object in each of the first images is obtained.

In some embodiments, the recognition results of the target objects in any two first images may be the same or different. Exemplarily, the recognition result of the target objects in the first image a is: playing card 1 value 5 number 10, playing card 2 value 6 number 15 and playing card 3 value 15 number 3; the recognition result of the target objects in the first image b is: playing card 1 value 5 number 10, playing card 2 value 6 number 15 and playing card 3 value 15 number 3; among them, the playing card 1 value 5 number 10 represents that the number of playing cards with their category being playing card 1 and with each of their card values being 5 is 10, the rest of recognition result represents similar meanings, which will not be repeated here.

In S104, a target recognition result of the target object is determined based on the recognition results of the target objects in the at least two consecutive frames of first images.

In some embodiments, the target recognition result of the target object is determined according to the recognition results of the target object in at least two consecutive frames of first images; the recognition results of the target object in the at least two consecutive frames of first images may be classified, and the number of recognition results included in each of the classes is determined, and the recognition result corresponding to the largest number is determined as the target recognition result of the target object. Alternatively, a number greater than a preset value may be selected from the numbers of recognition results included in respective classes, and a recognition result corresponding to the selected number is determined as the target recognition result of the target object.

In some embodiments, the target recognition result of the target object is obtained by performing statistics on the recognition result of the target object in at least two consecutive frames of first images. In this way, it is possible to reduce the occurrence of object recognition errors in cases with small probability of occurrence, and thus improve the accuracy of object recognition.

In the object recognition method according to the embodiments of the present disclosure, firstly, at least two consecutive frames of first images each including an image of at least one target object are acquired; secondly, a mapping relationship between each of the first images and a preset standard image associated with the target object is determined; then, object recognition is performed on the target object in each of the first images based on the mapping relationship to obtain a recognition result of the target object in each of the first images; and finally, a target recognition result of the target object is determined based on the recognition results of the target objects in the at least two consecutive frames of first images. In such a way, based on the mapping relationship with the preset standard image, object recognition is performed on the target objects in at least two consecutive frames of first images, and the recognition results of the target objects in at least two consecutive frames of first images are obtained, and the target recognition result of the target object is determined based on the recognition results of the target objects in at least two consecutive frames of first images. In this way, it is possible to reduce the occurrence of object recognition errors in cases with small probability of occurrence, and thus improve the accuracy of object recognition.

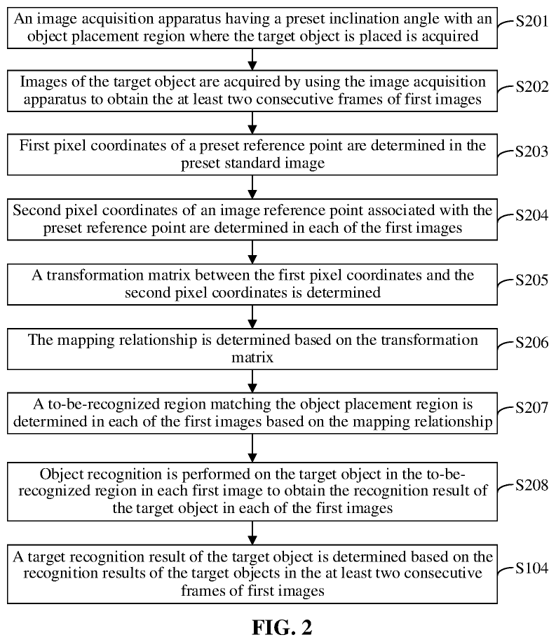

In some embodiments, the recognition result of the target object in each of the first images is obtained by performing object recognition on the target object in the to-be-recognized region matching the object placement region in each of the first images. In such a way, the accuracy of object recognition may be improved. As illustrated in FIG. 2, FIG. 2 illustrates a flow realization diagram of a second object recognition method according to an embodiment of the present disclosure; the following description will be made with reference to the steps shown in FIG. 1 and FIG. 2.

In S201, an image acquisition apparatus having a preset inclination angle with an object placement region where the target object is placed is acquired.

In some embodiments, the image acquisition apparatus may be installed on the top of the object placement region, and the top view is obtained by acquiring images of the object placement region where the target object is placed. The preset inclination angle may be 90 degrees or less than 90 degrees. Furthermore, the preset inclination angle may also be determined according to the actual image acquisition requirements of the application scene where the target object corresponds.

In some embodiments, when the target object is a stacked game prop on the game table, the image acquisition apparatus may be an image acquisition device with a preset inclination angle to the game table, etc.; when the target object is a chess piece on the board, the image acquisition apparatus may be an image acquisition apparatus with a preset inclination angle to the board.

In S202, images of the target object are acquired by using the image acquisition apparatus to obtain the at least two consecutive frames of first images.

In some embodiments, an image acquisition apparatus is adopted to acquire images of the target object placed in the object placement region to obtain at least two consecutive frames of first images; the image acquisition angle of each of the first images in the at least two consecutive frames of first images is the same, and the postures of the image acquisition apparatus corresponding to any two first images may be the same or different.

In some embodiments, the image acquisition apparatus may be adopted to perform real-time image acquisition of the target object placed in the object placement region within a preset period of time to obtain at least two consecutive frames of first images. In such a way, a top view real-time image of consecutive frames of images each including the image of the at least one target object may be efficiently obtained.

Here, determining the mapping relationship between each of the first images and the preset standard image associated with the target object, that is, S102 in the above embodiment, may be implemented by the following steps S203 to S206.

In S203, first pixel coordinates of a preset reference point are determined in the preset standard image.

In some embodiments, the preset reference point may refer to at least four vertices associated with the target object in the preset standard image, or at least four vertices associated with the object placement region of the target object; the first pixel coordinates of the reference point are the pixel coordinates of the preset reference point in the preset standard image, which may be represented by (x1, y1).

In some embodiments, the preset reference point may be preset in advance.

Here, determining the preset standard image associated with the target object may be implemented by the following process.

In a first step, the first acquisition angle of each of the first images is determined.

In some embodiments, the object recognition apparatus determines the first acquisition angle of each of the first images; the first acquisition angle may refer to the angle when the image acquisition apparatus acquires the images of the target object, that is, the angle between the image acquisition apparatus and the object placement region where the target object is located. The first acquisition angle may be changed according to actual needs, and the first acquisition angles of any two first images may be the same or different.

In a second step, an image of the target object placed in the object placement region is acquired with a second acquisition angle to obtain the preset standard image.

A difference between the second acquisition angle and the first acquisition angle is less than a preset angle threshold.

In some embodiments, the image of the target object placed in the object placement region is acquired with the second acquisition angle whose difference with the first acquisition angle is less than the preset angle threshold to obtain the preset standard image; the preset standard image may be obtained by acquiring an image of the target object by an image acquisition apparatus arranged perpendicular to the center of the object placement region; the preset standard image may also be obtained by an image acquisition apparatus that captures the first image. In such a way, the top view standard image corresponding to the first image, that is, the preset standard image, may be efficiently acquired, and the accuracy of subsequent recognition of the target object in the first image may be further improved.

In S204, second pixel coordinates of an image reference point associated with the preset reference point are determined in each of the first images.

In some embodiments, in each of the first images, the image reference point associated with the preset reference point may be preset in advance; furthermore, the second pixel coordinates of the image reference point are pixel coordinates of the image reference point in each of the first images, may be represented by (x2, y2).

In some embodiments, the second pixel coordinates in each of the first images may be completely the same, may also be partially the same, or may be completely different.

In S205, a transformation matrix between the first pixel coordinates and the second pixel coordinates is determined.

In some embodiments, a perspective transformation matrix (that is, the transformation matrix) between the first pixel coordinates and the second pixel coordinates is determined, where perspective transformation is used to project an image to a new viewing plane, and is a transformation through which oblique lines that may appear in the image can be converted into straight lines.

In S206, the mapping relationship is determined based on the transformation matrix.

In some embodiments, the mapping relationship may be directly represented based on the transformation matrix. In such a way, the accuracy of the mapping relationship between the determined preset standard image and each of the first images may be improved.

Here, based on the mapping relationship, object recognition is performed on the target object in each of the first images to obtain the recognition result of the target object in each of the first images, that is, S103 in the above embodiments may be implemented through the following steps S207 to S208.

In S207, a to-be-recognized region matching the object placement region is determined in each of the first images based on the mapping relationship.

In some embodiments, based on the mapping relationship between each of the images and the preset standard image, the to-be-recognized region that matches the object placement region is determined in each of the first images; the position, size and shape of the occupied region of the to-be-recognized region in each of the first images may be the same or different.

In a possible implementation, based on the mapping relationship, the image reference region matching the object placement region in the preset standard image may be projected into each of the first images to obtain the to-be-recognized region matching the object placement region in each of the first images, that is, the above S207 may be implemented by the following steps S271 and S272 (not illustrated in the figure).

In S271, an image reference region that matches the object placement region and is represented in a manner of vertices is determined in the preset standard image.

In some embodiments, the object placement region in the preset standard image may be recognized by using a target recognition algorithm to determine the image reference region. The shape of the image reference region in the preset standard image is exactly the same as the object placement region, and the size may be the same or different.

In some embodiments, the image reference region may be represented in a manner of vertices, that is, the image reference region is represented by linearly connecting multiple vertices of the image reference region in sequence in order of positions of the vertices. Exemplarily, in the case where the object placement region is a square, the image reference region is represented as a square in a manner of four vertices; in the case where the object placement region is a trapezoid, the image reference region is represented as a trapezoid in a manner of four vertices.

In S272, the image reference region is projected into each of the first images based on the mapping relationship to obtain the to-be-recognized region in each of the first images.

In some embodiments, the image reference region is projected into each of the images by adopting a mapping relationship, that is, a transformation matrix between each of the first images and a preset standard image, and correspondingly, the to-be-recognized region is obtained in each of the first images.

In some embodiments, the pixel coordinates of each of the vertices of the image reference region in the preset standard image may be projected into each of the first images based on the mapping relationship, and correspondingly, multiple pixel coordinates are determined in each of the first images; and then the multiple pixel coordinates of the vertices in each of the first image are linearly connected in turn to obtain the to-be-recognized region in each of the images. In this way, by determining the region in the preset standard image, and calculating the corresponding to-be-recognized region in each of the first images based on the mapping relationship, the amount of calculation may be reduced while improving the accuracy of determining the to-be-recognized region in each of the first images.

In S208, object recognition is performed on the target object in the to-be-recognized region in each first image to obtain a recognition result of the target object in each of the first images.

In some embodiments, object recognition is performed on the target object placed in the to-be-recognized region in each of the first images to obtain the recognition result of the target object in each of the first images; the recognition result of the target object in each of the first images may be the same or different.

In some embodiments, based on the mapping relationship with the preset standard image, the to-be-recognized region of each of the first images is determined, and furthermore, object recognition is performed on the target object in the to-be-recognized region that matches the object placement region in each of the first images to obtain the recognition result of the target object in each of the first images. In such a way, the accuracy of object recognition may be improved.

In a possible implementation, by performing object recognition on the target object in the to-be-recognized region in each of the first images, the recognition information of the target object in each of the first images and the number corresponding to each recognition information, that is, the recognition result of the target object in each of the first images, is determined. In such a way, the recognition result of the target object in each of the first images may be determined. That is, the above S208 may be implemented by the following steps S281 to S283 (not illustrated in the figure).

In S281, object recognition is performed on the target object in the to-be-recognized region in each of the first images to obtain recognition information of the target object in each of the first images.

In some embodiments, object recognition is performed on the target object in the to-be-recognized region in each of the first images to obtain the recognition information of the target object in each of the first images; the recognition information of the target object may refer to the category of the target object, the digital information presented on the surface of the target object, etc.

In some possible implementations, the recognition information of the target object includes at least one of:

a category of the target object, a value of the target object, a material of the target object, or a size of the target object.

In some embodiments, the recognition information of the target object may include, but is not limited to: the category of the target object, the value of the target object, the material of the target object, and the size of the target object. When the target object is a playing card, the category of the target object is the suit type of the playing card (hearts, spades, diamonds and clubs), the value of the target object is the card value of the playing card, and the material of the target object is coated paper, white cardboard or gray cardboard, etc., and the size of the target object is 5.7 cm*8.8 cm, etc.

In some embodiments, in the case where the target object is a playing card and a game token placed at a fixed position on the game table, the recognition information of the target object includes: playing cards and game tokens, and the card value and token value corresponding to each of the playing cards and game tokens, the materials and sizes corresponding to the playing cards and game tokens. Furthermore, the recognition information of the target object in each of the first images may be the same, or different from one another.

Herein, based on several examples of recognition information (category, value, material, and size), it is possible to improve the accuracy in subsequently determining the recognition result of the target object according to the recognition information.

In S282, the target object in each of the first images is classified based on the recognition information of the target object, and determining the number corresponding to each recognition information of the target object in each of the first images.

In some embodiments, the target object in each of the first image may continue to be classified based on the recognition information, that is, statistics on the target object in each of the first images is performed in turn according to the recognition information of the target object to determine the number corresponding to each recognition information of the target object in each of the first images.

In some embodiments, in the case where the target objects are playing cards placed at a fixed position on the game table, and the recognition information is the category and value of the playing card, the following can be obtained: in the first image A, the number of hearts cards with the value of 4 is 2, and the number of hearts cards with the value of 7 is 1, the number of spades cards with the value of 10 is 3, etc.; in the first image B, the number of hearts cards with the value of 4 is 2, the number of hearts cards with the value of 7 is 1, and the number of spades cards with the value of 10 is 4, etc. Herein, cards of the same category and value may be stacked.

In S283, the recognition information of the target object in each of the first images and the number corresponding to each recognition information is determined as the recognition result of the target object in each of the first images.

In some embodiments, the recognition information of the target object in each of the first images and the number corresponding to each recognition information may be determined as the recognition result of the target object in each of the first images. Exemplarily, the recognition result of the target object in each of the first images may be represented by adopting (category, value, number). Exemplarily, the recognition result of target objects in the first image A is: (category 1, value 1, number 1), (category 1, value 2, number 2), and (category 2, value 1, number 3).

In some embodiments, when the target object is a card placed on the game table, the recognition result of target objects in the first image A is: the number of hearts cards with the value of 4 is 2, the number of hearts cards with the value of 7 is 1, and the number of spades cards with the value of 10 is 3; the recognition result of target objects in the first image B is: the number of hearts cards with the value of 4 is 2, the number of hearts cards with the value of 7 is 1, and the number of spades cards with the value of 10 is 3; the recognition result of target objects in the first image C is: the number of hearts cards with the value of 4 is 2, the number of hearts cards with the value of 7 is 2, and the number of spades cards with the value of 10 is 3.

In some embodiments, by performing statistics on the recognition information of the target object in each of the first images and the number corresponding to the recognition information, the recognition result of the target object in each of the first images is determined. In such a way, by determining the recognition information of the target result in each of the first images and the number corresponding to each recognition information, the accuracy of object recognition in each of the first images may be improved.

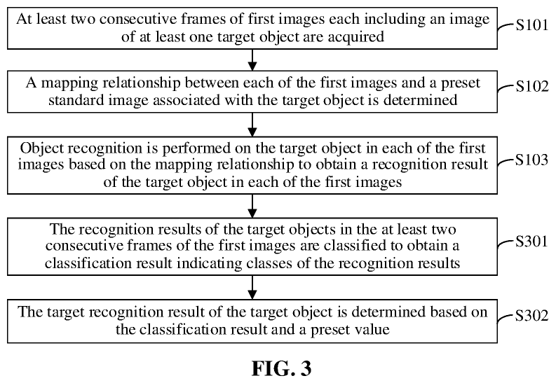

In some embodiments, based on the recognition results of the target objects in at least two consecutive frames of first images, the recognition result of the target object is determined. In such a way, the probability of errors in the recognition result may be reduced, and furthermore, the accuracy of object recognition may be improved. As illustrated in FIG. 3, FIG. 3 illustrates a schematic flowchart of a third object recognition method according to an embodiment of the present disclosure; the following description will be made with reference to the steps shown in FIG. 1 and FIG. 3.

In S301, the recognition results of the target objects in the at least two consecutive frames of first images are classified to obtain a classification result indicating classes of the recognition results.

In some embodiments, the recognition result of the target object in each of the first images of the at least two consecutive frames of first images is classified to obtain the classification result; that is, according to the category, value, and the number corresponding to each category and each value, statistics are performed on the recognition result corresponding to each of the first images, that is, same recognition results of at least two consecutive frames of first images are classified into one class.

In some embodiments, the at least two consecutive frames of first images include the first image A, the first image B, the first image C, the first image D, and the first image E; the recognition results of the target objects in the at least two consecutive frames of first images are classified based on the recognition result of the target object in each of the first images; and the recognition results obtained from the first image A, the first image B, the first image C and the first image D are determined as the first class of results, and the first image E is determined as the second class of results.

In S302, the target recognition result of the target object is determined based on the classification result and a preset value.

A preset ratio between the preset value and a number of the at least two consecutive frames of first images is less than 1, and the preset value is a positive integer.

In some embodiments, a preset ratio between the preset value and a number of the at least two consecutive frames of first images is less than 1, the preset value is a positive integer, and the preset ratio may be 50%, 60%, or the like. For example, the preset value may be half of the number of at least two consecutive frames of first images; exemplarily, the number of at least two consecutive frames of first images is 5, and the preset value is 3; the number of at least two consecutive frames of first images is 10, the preset value is 5.

In some embodiments, the target recognition result of the target object is determined based on the classification result and the preset value, that is, the target recognition result of the target object is determined according to the ratio between the corresponding number of each of the categories of recognition results in the classification result and the preset value. In such a way, the optimal result may be selected from multiple recognition results, and compared with a single recognition result, the probability of errors in a single recognition result may be greatly reduced.

In some possible implementations, the target recognition result of the target object is determined by the number corresponding to each of the classes in the classification results and the preset value. In this way, it is possible to reduce the occurrence of object recognition errors in cases with small probability of occurrence, and thus improve the accuracy of object recognition. That is, the above S302 may be implemented by the following steps S321 and S322 (not illustrated in the figure).

In S321, a number corresponding to each of the classes is determined based on the classification result.

In some embodiments, the recognition results of the target objects in the at least two consecutive frames of first images are classified based on the recognition result of the target object to obtain the classification result, and furthermore, the number corresponding to each of the classes is determined.

In some embodiments, the at least two consecutive frames of first images include first image A, first image B, first image C, first image D, first image E, first image F, first image G, first image H and first image I; the recognition results of the target objects in the at least two consecutive frames of first images are classified based on the recognition result of the target object in each of the first images; and the recognition results obtained from the first image A, the first image B, the first image C, and the first image D, the first image E and the first image F are determined to be the first class of results, the first image G is determined to be the second class of results, and the recognition results obtained from the first image H and the first image I are determined to be the third class of results. The recognition result of the first image in each class of results is the same; furthermore, the number corresponding to the first class of results is 6, the number corresponding to the second class of results is 1, and the number corresponding to the third class of results is 2.

In S322, a recognition result of a class corresponding to a first number greater than the preset value is determined as the target recognition result of the target object, in a case where the numbers corresponding to the classes include a number greater than the preset value.

In some embodiments, in a case where the numbers corresponding to the classes include a number greater than the preset value, the recognition result recognition result of the class corresponding to the first number greater than the preset value is determined as the target recognition result of the target object.

As shown in the above examples, at least two consecutive frames of first images are 9 frames of images, including: the first image A, the first image B, the first image C, the first image D, the first image E, the first image F, the first image G, the first image H and the first image I. In the case where the first image A, the first image B, the first image C, the first image D, the first image E and the first image F are the first class of results, the first image G is the second class of results, the first image H and the first image I are the third class of results, and the preset value is 5, then the number corresponding to the first class of results is 6, which is greater than the preset value, the recognition result corresponding to the first class of results is considered to be the target recognition result of the target object. The recognition result corresponding to the first class of results is the recognition result of the target object in any of the first image A, the first image B, the first image C, the first image D, the first image E or the first image F, and the recognition results are all the same.

In some embodiments, from the recognition result of the target object in the multiple consecutive frames of first images, a recognition result corresponding to the number of occurrences of the same recognition result greater than the preset value is determined as the target recognition result of the target object. In such a way, the recognition result with a small number of occurrences may be removed, and it is possible to reduce the occurrence of object recognition errors in cases with small probability of occurrence, and thus improve the accuracy of object recognition.

In some possible implementations, the number corresponding to each of the classes is compared with the preset value, and in a case where the numbers corresponding to the classes do not include a number greater than the preset value, the following steps may also be performed.

In a first step, in a case where the numbers corresponding to the classes do not include a number greater than the preset value, a second number having a largest value is selected from the numbers.

In some embodiments, in a case where the numbers corresponding to the classes do not include a number greater than the preset value, a second number having a largest value is selected from the numbers corresponding to the classes.

As shown in the above examples, at least two consecutive frames of first images are 8 frames of images, including: the first image A, the first image B, the first image C, the first image D, the first image E, the first image F, the first image G and the first image H. In the case where the first image A, the first image B and the first image C are the first class of results, the first image D and the first image E are the second class of results; the first image F is the third class of results, and the first image G and the first image H are the fourth class of results, the number corresponding to the first class of results is 3, the number of the second class of results is 2, and the number of the third class of results is 1, and the number of the fourth class of results is 2.

In a second step, a recognition result of a class corresponding to the second number is determined as the target recognition result of the target object, and alarm information is issued.

In some embodiments, the recognition result of the class corresponding to the second number is determined as the target recognition result of the target object, where there may be at least one second number.

As shown in the above examples, the second number is the number corresponding to the first class of results, and then the recognition result of the class corresponding to the second number, that is, the recognition result corresponding to the first class of results, is determined as the target recognition result of the target object; in other words, the recognition result of the target object in any one of the first image A, the first image B and the first image C is determined as the target recognition result.

In some embodiments, in a case where the numbers corresponding to the classes do not include a number greater than the preset value, alarm information needs to be issued, that is, information is issued that indicates there are multiple different results among the recognition results of the target object in the multiple consecutive frames of first images. In such a way, for cases where there may be multiple object recognition errors, alarm information is issued to provide a basis for subsequent improvement of the accuracy of the object recognition model.

In some embodiments, in the case where the number of occurrences of a same recognition result does not exceed the preset value, the same recognition result having the most frequent occurrence is determined from the recognition results of the target objects in multiple consecutive frames of first images, as the target recognition result of the target object. In such a way, the recognition result with a small number of occurrences may be removed. In this way, it is possible to reduce the occurrence of object recognition errors in cases with small probability of occurrence, and thus improve the accuracy of object recognition.

The above object recognition method will be described below in combination with a specific embodiment. However, it is worth noting that this specific embodiment is only for better describing the embodiments of the present disclosure, and does not constitute an improper limitation on the embodiments of the present disclosure.

In gaming venues, it is usually necessary to count the total number of game tokens in certain regions on the game table; however, since the game tokens are generally stacked according to the token value of the game tokens, the accuracy of the algorithm for recognizing the game tokens is higher. After the accuracy of the algorithm is increased to a certain level, there will be a bottleneck, that is, errors with small probability of occurrence may be generated. By the object recognition method proposed in the above embodiments, the probability of errors in recognizing stacked game tokens may be reduced, which is achieved by the following steps.

In a first step, image acquisition is performed on multiple stacks of game tokens placed in a specific region on the game table to obtain a top view standard image and a top view real-time image respectively. The state of each of the game tokens in the top view standard view is exactly the same as the state of looking down on each of the game tokens from a vertical angle; the real-time top image may be multiple consecutive frames of images obtained by acquiring images of the game tokens placed on the game table at any inclination angle; furthermore, the game tokens are not occluded in the top view standard image or the top view real-time image.

If there are cases where the game tokens are occluded in the multiple frames of images obtained by acquiring images of the game tokens placed on the game table at any inclination angle, the occluded images are filtered out to obtain multiple top view real-time images without occluded game tokens.

In a second step, the mapping T from the top view standard image to the top view real-time image, that is, the mapping relationship between the top view standard image and the top view real-time image, is obtained by the adaptive method; herein, the mapping may be obtained according to the pixel coordinates of multiple actual reference points of the game table in the top view standard image and pixel coordinates of the corresponding reference points in the top view real-time image.

In a third step, the image reference region A, where multiple stacks of game tokens are placed and which may be a polygonal region, is determined in the top view standard image, and the image reference region A may be represented in a manner of vertices.

In a fourth step, based on the image reference region A and the mapping T, the to-be-recognized region A′ mapped from the image reference region A to each of the top view real-time is calculated; a binary mask image may be generated according to the to-be-recognized region A′ and the size of the top view real-time image, where 1 represents that the object is inside to-be-recognized region A′, and 0 represents that the object is outside the to-be-recognized region A′.

In a fifth step, object recognition is performed on each of the top view real-time images; object recognition may be performed on the to-be-recognized region A′ in each of the top view real-time images. Furthermore, a corresponding identity document (ID) is generated when object recognition is performed on the to-be-recognized region A′ in each of the top view real-time images. For each ID, the recognition result of each time may be represented by a character string. The representation method is: each of game tokens with the same face value and the same type is represented by “value_type”; game tokens with the same face value and the same type may be represented by valueN_typeN*numN, where numN represents the number of game tokens with the same face value and the same type; different game tokens may be separated by “|”. Therefore, the recognition result of each of the top view images may be expressed by: value1_type1*num1|value2_type2*num2|. . . |valueN_typeN*numN|.

In a sixth step, the recognition result of each ID is compared with that of another ID to determine whether there are recognition results that are exactly the same. If they are the same, the number of times is incremented by 1, and if they are not the same, the number of times remains unchanged. The occurrence times of different recognition results are counted, which are represented in the form of result 1: times 1, result 2: times 2, . . . , result N: times N. The total number of multiple recognition results is M. If the number of times corresponding to a recognition result exceeds M/2, the recognition result is directly taken as the final recognition result. If not, the recognition result with the largest number of times is taken as the final recognition result, and an alarm is issued. M screenshots of the target object of the ID and the recognition result of the target object are stored, so as to provide a basis for the subsequent improvement of the accuracy of the object recognition model.

By the above steps, the multiple continuous top view real-time images are counted separately, and the recognition result with the most occurrences is selected as the final target recognition result with each stack of game tokens as a unit. Furthermore, an alarm is issued and recorded for multiple unstable object recognition results for model training to improve the accuracy of object recognition. The to-be-recognized region is determined in the top view real-time image based on the mapping relationship between the top view standard image and the top view real-time image and based on the more standard recognition region in the top view standard image, it is thus possible to reduce the complexity of data processing and improve the accuracy of the recognition result. Furthermore, compared with the recognition result of a single image, by screening multiple recognition results according to a preset strategy, the error probability of the recognition result may be reduced. In addition, the wrong recognition results may be stored for later training of the object recognition model.

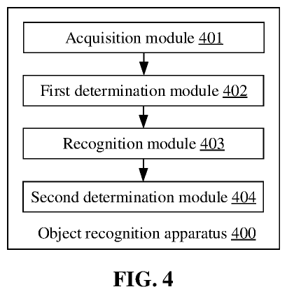

The embodiments of the present disclosure provide an object recognition apparatus. FIG. 4 illustrates a schematic composition diagram of the object recognition apparatus according to an embodiment of the present disclosure, as illustrated in FIG. 4, the object recognition apparatus 400 includes an acquisition module 401, a first determination module 402, a recognition module 403, and a second determination module 404.

The acquisition module 401 is configured to acquire at least two consecutive frames of first images each including an image of at least one target object;

The first determination module 402 is configured to determine a mapping relationship between each of the first images and a preset standard image associated with the target object;

The recognition module 403 is configured to perform object recognition on the target object in each of the first images based on the mapping relationship to obtain a recognition result of the target object in each of the first image;

The second determination module 404 is configured to determine a target recognition result of the target object based on the recognition results of the target objects in the at least two consecutive frames of first images.

In some embodiments, the acquisition module 401 may be further configured to acquire an image acquisition apparatus having a preset inclination angle with an object placement region where the target object is placed, and acquire images of the target object by using the image acquisition apparatus to obtain the at least two consecutive frames of first images.

In some embodiments, the object recognition apparatus 400 may further includes: an angle determination module that is configured to determine a first acquisition angle of each of the first images; and an acquisition module 401 that is configured to acquire an image of the target object placed in the object placement region with a second acquisition angle to obtain the preset standard image, where a difference between the second acquisition angle and the first acquisition angle is less than a preset angle threshold.

In some embodiments, the first determination module 402 may be further configured to determine the first pixel coordinates of the preset reference point in the preset standard image; determine the second pixel coordinates of the image reference point, associated with the preset reference point, in each of the first images; determine the transformation matrix between the first pixel coordinates and the second pixel coordinates; and determine the mapping relationship based on the transformation matrix.

In some embodiments, the recognition module 403 may include a region determination sub-module that is configured to determine a to-be-recognized region matching the object placement region in each of the first images based on the mapping relationship; and an object recognition sub-module that is configured to perform object recognition on the target object in the to-be-recognized region in each first image to obtain a recognition result of the target object in each of the first images.

In some embodiments, the region determination sub-module may be further configured to: determine an image reference region that matches the object placement region and is represented in a manner of vertices in the preset standard image; and project the image reference region into each of the first images based on the mapping relationship to obtain the to-be-recognized region in each of the first images.

In some embodiments, the object recognition sub-module may be further configured to: perform object recognition on the target object in the to-be-recognized region in each of the first images to obtain recognition information of the target object in each of the first images; classify the target object in each of the first images based on the recognition information of the target object, and determining the number corresponding to each recognition information of the target object in each of the first images; and determine, as the recognition result of the target object in each of the first images, the recognition information of the target object in each of the first images and the number corresponding to each recognition information.

In some embodiments, the recognition information of the target object may include at least one of: a category of the target object, a value of the target object, a material of the target object, or a size of the target object.

In some embodiments, the second determination module 404 may include: a classification sub-module that is configured to classify the recognition results of the target objects in the at least two consecutive frames of first images to obtain a classification result indicating classes of the recognition results; and a determination sub-module that is configured to determine the target recognition result of the target object based on the classification result and a preset value, where a preset ratio between the preset value and a number of the at least two consecutive frames of first images is less than 1, and the preset value is a positive integer.

In some embodiments, the determination sub-module may include: a number determination sub-unit that is configured to determine the number corresponding to each of the classes based on the classification result; and a recognition result determination sub-unit that is configured to, in a case where the numbers corresponding to the classes include a number greater than the preset value, determine, a recognition result of a class corresponding to a first number greater than the preset value, as the target recognition result of the target object.

In some embodiments, the recognition result determination sub-unit may be further configured to: in a case where the numbers corresponding to the classes do not include a number greater than the preset value, select a second number having a largest value from the numbers; and determine, a recognition result of a class corresponding to the second number, as the target recognition result of the target object, and issue alarm information.

It should be noted that the descriptions of the above apparatus embodiments are similar to the descriptions of the above method embodiments, and have similar beneficial effects as the method embodiment. For technical details not disclosed in the device embodiments of the present disclosure, please refer to the description of the method embodiments of the present disclosure for understanding.

It should be noted that, in the embodiments of the present disclosure, if the above object recognition method is implemented in the form of a software function module and sold or used as an independent product, it may also be stored in a computer readable storage medium. According to this understanding, the technical solutions in the embodiments of the present disclosure may be embodied in the form of a software product in essence or a part that contributes to the prior art. The computer software product is stored in a storage medium and includes several instructions such that a computer device (which may be a terminal, a server, etc.) executes all or part of the method described in each of the embodiments of the present disclosure. The above storage media include: an U disk, a sports hard disk, a read only memory (ROM), a magnetic disk or an optical disk and other media that can store program codes. In such a way, the embodiments of the present disclosure are not limited to any specific combination of hardware and software.

Correspondingly, the embodiments of the present disclosure further provide a computer program product. The computer program product includes computer-executable instructions. After the computer-executable instructions are executed, the object recognition method according to the embodiments of the present disclosure may be implemented.

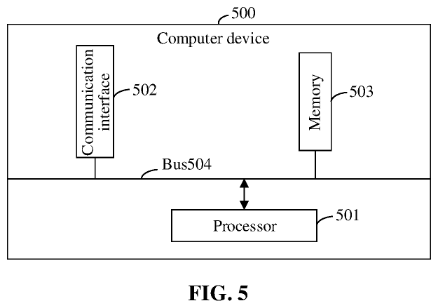

Correspondingly, the embodiments of the present disclosure provide a computer device. FIG. 5 illustrates a schematic composition diagram of a computer device according to an embodiment of the present disclosure. As illustrated in FIG. 5, the computer device 500 includes: a processor 501, at least one communication bus 504, a communication interface 502, at least one external communication interface and a memory 503. The communication interface 502 is configured to implement connection and communication between these components. The communication interface 502 may include a display screen, and the external communication interface may include a standard wired interface and a wireless interface. The processor 501 is configured to execute an image processing program in the memory to implement the object recognition method according to the above embodiments.

Correspondingly, the embodiments of the present disclosure further provide a computer storage medium having computer-executable instructions stored thereon, and when the computer-executable instructions are executed by a processor, the object recognition method according to the above embodiments is implemented.

The above descriptions of the object recognition apparatus, computer device, and storage medium embodiment are similar to the descriptions of the above method embodiments, and have similar technical descriptions and beneficial effects as the corresponding method embodiments. Due to space limitations, the descriptions of the above method embodiments may be followed, which will not be repeated herein. For technical details not disclosed in the embodiments of the object recognition apparatus, computer device, and storage medium of the present disclosure, please refer to the descriptions in the method embodiments of the present disclosure for understanding.

It should be understood that the “one embodiment” or “an embodiment” mentioned throughout the specification means that a specific feature, structure, or characteristic related to the embodiments is included in at least one embodiment in the embodiments of the present disclosure. Therefore, the appearances of “in one embodiment” or “in an embodiment” in various places throughout the specification do not necessarily refer to the same embodiment. In addition, these specific features, structures, or characteristics may be combined in one or more embodiments in any suitable manner. It should be understood that, in the various embodiments in the embodiments of the present disclosure, the size of the sequence numbers of the above processes does not mean the order of execution. The execution order of various processes should be determined by their functions and internal logic, and should not constitute any limitation to the implementation process in the embodiments of the present disclosure. The sequence numbers in the above embodiments of the present disclosure are only for description, and do not represent the superiority or inferiority of the embodiments. It should be noted that in this article, the terms “include”, “contain or any other variants thereof are intended to cover non-exclusive inclusion, so that a process, method, article or apparatus including a series of elements not only includes those elements, but also includes other elements that are not explicitly listed, or elements inherent to the process, method, article, or apparatus. In the case where there are no more restrictions, the element defined by the sentence “including a . . . ” does not exclude the existence of other same elements in the process, method, article, or apparatus that includes the element.

In the several embodiments according to the embodiments of the present disclosure, it should be understood that the disclosed device and method may be implemented in other ways. The device embodiments described above are merely illustrative. For example, the division of the units is only a logical function division, and there may be other divisions in actual implementation, such as: multiple units or components may be combined, or they may be integrated into another system, or some features may be ignored or not implemented. In addition, the coupling, or direct coupling, or communication connection between the components shown or discussed may be indirect coupling or communication connection through some interfaces, devices or units, and may be in electrical, mechanical or other forms.

The units described above as separate components may or may not be physically separate, and the components displayed as units may or may not be physical units; they may be located in one place or distributed on a plurality network units; some or all of the units may be selected according to actual needs to achieve the object of the solution of this embodiment.

In addition, the functional units in the various embodiments in the embodiments of the present disclosure may all be integrated into one processing unit, or each unit may be individually taken as a unit, or two or more units may be integrated into one unit; the above integrated unit may be implemented in the form of hardware, or may be implemented in the form of hardware plus software functional units. A person of ordinary skill in the art may understand that all or part of the steps in the above method embodiments may be implemented by a program instructing relevant hardware. The above program may be stored in a computer readable storage medium. When the program is executed, the steps including the above method embodiments are performed; and the above storage medium includes: various media that may store program codes, such as a mobile storage device, a read only memory (ROM), a magnetic disk, or an optical disk.

Alternatively, if the above integrated units in the embodiments of the present disclosure are implemented in the form of a software function module and sold or used as an independent product, they may also be stored in a computer readable storage medium. According to this understanding, the technical solutions in the embodiments of the present disclosure may be embodied in the form of a software product in essence or a part that contributes to the prior art. The computer software product is stored in a storage medium and includes several instructions such that a computer device (which may be a personal computer, a server, or a network device, etc.) executes all or part of the methods described in the various embodiments in the embodiments of the present disclosure. The above storage media includes: a mobile storage devices, a ROM, a magnetic disk or an optical disk and other media that may store program codes. The above are only specific implementations in the embodiments of the present disclosure, but the protection scope in the embodiments of the present disclosure is not limited to this. Any person familiar with the technical field may easily conceive of changes or replacements within the technical scope disclosed in the embodiments of the present disclosure, and they should be covered within the protection scope in the embodiments of the present disclosure. Therefore, the protection scope in the embodiments of the present disclosure should be subject to the protection scope of the claims.

1. An object recognition method, comprising:
acquiring at least two consecutive frames of first images each comprising an image of at least one target object;
determining a mapping relationship between each of the first images and a preset standard image associated with the target object;
performing object recognition on the target object in each of the first images based on the mapping relationship to obtain a recognition result of the target object in each of the first images; and
determining a target recognition result of the target object based on the recognition results of the target objects in the at least two consecutive frames of first images.

2. The method of claim 1, wherein acquiring the at least two consecutive frames of first images each comprising the image of the at least one target object comprises:
acquiring an image acquisition apparatus having a preset inclination angle with an object placement region where the target object is placed; and
acquiring images of the target object by using the image acquisition apparatus to obtain the at least two consecutive frames of first images.

3. The method of claim 2, further comprising: before determining the mapping relationship between each of the first images and the preset standard image associated with the target object,
determining a first acquisition angle of each of the first images; and
acquiring an image of the target object placed in the object placement region with a second acquisition angle to obtain the preset standard image, wherein a difference between the second acquisition angle and the first acquisition angle is less than a preset angle threshold.

4. The method of claim 1, wherein determining mapping relationship between each of the first images and the preset standard image associated with the target object comprises:
determining first pixel coordinates of a preset reference point in the preset standard image;
determining second pixel coordinates of an image reference point, associated with the preset reference point, in each of the first images;
determining a transformation matrix between the first pixel coordinates and the second pixel coordinates; and
determining the mapping relationship based on the transformation matrix.

5. The method of claim 2, wherein performing object recognition on the target object in each of the first images based on the mapping relationship to obtain the recognition result of the target object in each of the first images comprises:
determining a to-be-recognized region matching the object placement region in each of the first images based on the mapping relationship; and
performing object recognition on the target object in the to-be-recognized region in each of the first images to obtain the recognition result of the target object in each of the first images.

6. The method of claim 5, wherein determining the to-be-recognized region matching the object placement region in each of the first images based on the mapping relationship comprises:
determining, in the preset standard image, an image reference region that matches the object placement region and is represented in a manner of vertices; and
projecting the image reference region into each of the first images based on the mapping relationship to obtain the to-be-recognized region in each of the first images.

7. The method of claim 5, wherein performing object recognition on the target object in the to-be-recognized region in each of the first images to obtain the recognition result of the target object in each of the first images comprises:
performing object recognition on the target object in the to-be-recognized region in each of the first images to obtain recognition information of the target object in each of the first images;
classifying the target object in each of the first images based on the recognition information of the target object, and determining a number corresponding to each recognition information of the target object in each of the first images; and
determining, as the recognition result of the target object in each of the first images, the recognition information of the target object in each of the first images and the number corresponding to each recognition information.

8. The method of claim 7, wherein the recognition information of the target object comprises at least one of:
a category of the target object, a value of the target object, a material of the target object, or a size of the target object.

9. The method of claim 1, wherein determining the target recognition result of the target object based on the recognition results of the target objects in the at least two consecutive frames of first images comprises:
classifying the recognition results of the target objects in the at least two consecutive frames of first images to obtain a classification result indicating classes of the recognition results; and
determining the target recognition result of the target object based on the classification result and a preset value, wherein a preset ratio between the preset value and a number of the at least two consecutive frames of first images is less than 1, and the preset value is a positive integer.

10. The method of claim 9, wherein determining the target recognition result of the target object based on the classification result and the preset value comprises:
determining a number corresponding to each of the classes based on the classification result; and
in a case where the numbers corresponding to the classes comprise a number greater than the preset value, determining, a recognition result of a class corresponding to a first number greater than the preset value, as the target recognition result of the target object.

11. The method of claim 10, further comprising:
in a case where the numbers corresponding to the classes do not comprise a number greater than the preset value, selecting a second number having a largest value from the numbers; and
determining, a recognition result of a class corresponding to the second number, as the target recognition result of the target object, and issuing alarm information.

12. An object recognition apparatus, comprising:
a memory storing processor-executable instructions; and
a processor configured to execute the processor-executable instructions to perform operations of:
acquiring at least two consecutive frames of first images each comprising an image of at least one target object;
determining a mapping relationship between each of the first images and a preset standard image associated with the target object;
performing object recognition on the target object in each of the first images based on the mapping relationship to obtain a recognition result of the target object in each of the first images; and
determining a target recognition result of the target object based on the recognition results of the target objects in the at least two consecutive frames of first images.

13. The apparatus of claim 12, wherein acquiring the at least two consecutive frames of first images each comprising the image of the at least one target object comprises:
acquiring an image acquisition apparatus having a preset inclination angle with an object placement region where the target object is placed; and
acquiring images of the target object by using the image acquisition apparatus to obtain the at least two consecutive frames of first images.

14. The apparatus of claim 13, wherein the processor is configured to execute the processor-executable instructions to further perform operations of: before determining the mapping relationship between each of the first images and the preset standard image associated with the target object,
determining a first acquisition angle of each of the first images; and
acquiring an image of the target object placed in the object placement region with a second acquisition angle to obtain the preset standard image, wherein a difference between the second acquisition angle and the first acquisition angle is less than a preset angle threshold.

15. The apparatus of claim 12, wherein determining mapping relationship between each of the first images and the preset standard image associated with the target object comprises:
determining first pixel coordinates of a preset reference point in the preset standard image;
determining second pixel coordinates of an image reference point, associated with the preset reference point, in each of the first images;
determining a transformation matrix between the first pixel coordinates and the second pixel coordinates; and
determining the mapping relationship based on the transformation matrix.

16. The apparatus of claim 13, wherein performing object recognition on the target object in each of the first images based on the mapping relationship to obtain the recognition result of the target object in each of the first images comprises:
determining a to-be-recognized region matching the object placement region in each of the first images based on the mapping relationship; and
performing object recognition on the target object in the to-be-recognized region in each of the first images to obtain the recognition result of the target object in each of the first images.

17. The apparatus of claim 16, wherein determining the to-be-recognized region matching the object placement region in each of the first images based on the mapping relationship comprises:
determining, in the preset standard image, an image reference region that matches the object placement region and is represented in a manner of vertices; and
projecting the image reference region into each of the first images based on the mapping relationship to obtain the to-be-recognized region in each of the first images.

18. The apparatus of claim 16, wherein performing object recognition on the target object in the to-be-recognized region in each of the first images to obtain the recognition result of the target object in each of the first images comprises:
performing object recognition on the target object in the to-be-recognized region in each of the first images to obtain recognition information of the target object in each of the first images;
classifying the target object in each of the first images based on the recognition information of the target object, and determining a number corresponding to each recognition information of the target object in each of the first images; and
determining, as the recognition result of the target object in each of the first images, the recognition information of the target object in each of the first images and the number corresponding to each recognition information.

19. The apparatus of claim 18, wherein the recognition information of the target object comprises at least one of:
a category of the target object, a value of the target object, a material of the target object, or a size of the target object.

20. A non-transitory computer-readable storage medium having stored thereon computer executable instructions that, when executed by a processor, cause the processor to perform operations of:
acquiring at least two consecutive frames of first images each comprising an image of at least one target object;
determining a mapping relationship between each of the first images and a preset standard image associated with the target object;
performing object recognition on the target object in each of the first images based on the mapping relationship to obtain a recognition result of the target object in each of the first images; and
determining a target recognition result of the target object based on the recognition results of the target objects in the at least two consecutive frames of first images.
